(19) United States
(12) Patent Application Publication
(10) Pub. No.: US 2002/0058598 A1
(43) Pub. Date: May 16, 2002

(54) Laundry bleaching kit and method of bleaching a substrate

(75) Inventor: David Victor Avila, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/956,694

(22) Filed: Sep. 20, 2001

(30) Foreign Application Priority Data
Sep. 22, 2000 (GB) 0023322.1

(51) Int. Cl. D06L 1/00; C11D 3/00; C11D 7/18

(52) U.S. Cl. 510/302; 510/309; 510/313

(57) ABSTRACT

The invention relates to catalytically bleaching substrates, especially laundry fabrics, with atmospheric oxygen and selective application of a peroxyl species to specific types of stain.

### FIELD OF INVENTION

This invention relates to a commercial air bleaching laundry product together with instructions for its use. The invention also relates to a two step treatment for the bleaching of stains.

### BACKGROUND OF INVENTION

The use of bleaching catalysts for stain removal has been developed over recent years. The recent discovery that some catalysts are capable of bleaching effectively with air has recently become the focus of some interest, for example, GB applications: 9906474.3; 9907714.1; and 9907713.3 (all Unilever). As with any cleaning product a more economical use of active components and effective stain bleaching profile is sought.

In addition to the above, there is an increasing public awareness of environmental issues, in particular water pollution. The ubiquitous use of additives in laundry detergents results in substantial quantities of these additives ending up in waste water effluent. The public welcomes any reduction in these additives found in water waste effluent.

It is an object of the present invention to provide a product that is attractive to the consumer in terms of a product that contains less peroxyl species over that of present conventional peroxyl containing laundry detergents. In addition, it is also an object of the present invention to provide a product together with instructions so that a wider stain bleaching profile may be realised by the consumer than when an air bleaching laundry detergent is used in a single cleaning step.

### SUMMARY OF INVENTION

We have found that not all peroxyl-activating catalysts are capable of functioning as air bleaching catalyst. However, the converse is not true. All air bleaching catalysts function as peroxyl activation catalysts. We have also found that the majority of air bleaching catalysts, in air bleaching mode, are more effective against certain types of stains than others. In this regard, the present invention provides a method of selectively treating stains that are more resistant to air bleaching than others.

The consumer is aware what constitutes a catechol-type or polyphenolics-type or polycyclic hydroxylated aromatic-type stain but not in those terms. The consumer recognizes these stains as tea, coffee, blackberry, blueberry, blackcurrant, red wine, banana and the like. These stains are characteristic and distinct from oily food type stains such as tomato oil stain, curry oil stain, mango stain, annatto derived stain, colorau derived stain, and sebum derived stain etc.

It is the tea, coffee, blackberry, blueberry, blackcurrant, red wine, banana and stains of this type that are presently more resistant to bleaching with air than with a peroxyl species, with or without a peroxyl activating catalyst.

The present invention provides an air bleaching laundry detergent and instructions for its use with a peroxyl species. The present invention also extends to a kit comprising a laundry bleaching composition comprising an air bleaching product and an applicator containing a peroxyl species together with instructions for its use. As presently found in the patent literature many classes of compounds have been found to be suitable as air bleaching catalysts. It is inevitable that more classes of air bleaching catalysts will be discovered.

The present invention provides a commercial bleaching composition comprising an air bleaching catalyst for bleaching a substrate with atmospheric oxygen, the bleaching composition upon addition to an aqueous medium providing an aqueous bleaching medium substantially devoid of a peroxygen bleach or a peroxy-based or peroxyl-generating bleach system, together with instructions for the local application of a peroxygen bleach or a peroxy-based or a peroxyl-generating bleach system to a fabric stain before or after washing. In instances where the stain for treatment is dry it will be necessary to dampen a stained area to effect better stain removal. Suitable dampening means are in the form of liquids and gels containing water, alcohol, glycerol and the like.

The present invention also provides a laundry cleaning kit (kit of parts) comprising the commercial bleaching composition together with an applicator comprising a peroxygen bleach or a peroxy-based or peroxyl-generating bleach system for local application of the peroxygen bleach or the peroxy-based or the peroxyl-generating bleach system to a stained substrate.

The applicator comprising peroxygen bleach or a peroxy-based or peroxyl-generating bleach system for local application may also comprise a peroxyl-bleaching catalyst.

The present invention also extends to a method of treating a stain that is resistant to air bleaching.

### DETAILED DESCRIPTION OF THE INVENTION

Bleach Catalyst

The bleach catalyst per se may be selected from a wide range of transition metal complexes of organic molecules (ligands). Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and W00060045 the complexes and organic molecule (ligand) precursors of which are herein incorporated by reference.

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The transition metal complex preferably is of the general formula (AI):

[MₐLₖXₙ]Yₘ

in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe (II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

Preferably, the complex is an iron complex comprising the ligand N,N-bis(pyridin-2-yl-methyl)-1,1-bis(pyridin-2-yl)-1-aminoethane. Suitable classes of ligands are described below:

(A) Ligands of the General Formula (IA):

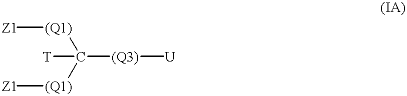

wherein

Z1 groups independently represent a coordinating group selected from hydroxy, amino, —NHR or —N(R)₂ (wherein R=C₁₋₆-alkyl), carboxylate, amido, —NH—C(NH)NH₂, hydroxyphenyl, a heterocyclic ring optionally substituted by one or more functional groups E or a heteroaromatic ring optionally substituted by one or more functional groups E, the heteroaromatic ring being selected from pyridine, pyrimidine, pyrazine, pyrazole, imidazole, benzimidazole, quinoline, quinoxaline, triazole, isoquinoline, carbazole, indole, isoindole, oxazole and thiazole;

Q1 and Q3 independently represent a group of the formula:

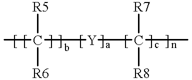

wherein

5≧a+b+c≧1; a=0-5; b=0-5; c=0-5; n=0 or 1

(preferably n=0);

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₆-alkylene optionally substituted by C₁₋₄-alkyl, —F, —Cl, —Br or —I;

T represents a non-coordinated group selected from hydrogen, hydroxyl, halogen, —R and —OR, wherein R represents alkyl, alkenyl, cycloalkyl, heterocycloalkyl, aryl, arylalkyl, heteroaryl or a carbonyl derivative group, R being optionally substituted by one or more functional groups E (preferably T=—H, —OH, methyl, methoxy or benzyl);

U represents either a non-coordinated group T independently defined as above or a coordinating group of the general formula (IIA), (IIIA) or (IVA):

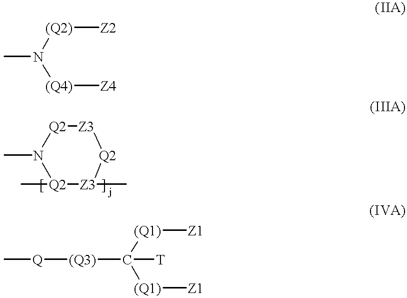

wherein

Q2 and Q4 are independently defined as for Q1 and Q3;

Q represents —N(T)— (wherein T is independently defined as above), or an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Z2 is independently defined as for Z1;

Z3 groups independently represent —N(T)— (wherein T is independently defined as above);

Z4 represents a coordinating or non-coordinating group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E, or Z4 represents a group of the general formula (IIAa):

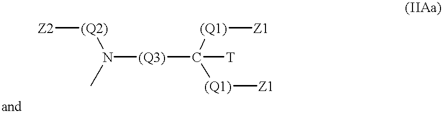

1≦j<4.

Preferably, Z1, Z2 and Z4 independently represent an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. More preferably, Z1, Z2 and Z4 independently represent groups selected from optionally substituted pyridin-2-yl, optionally substituted imidazol-2-yl, optionally substituted imidazol-4-yl, optionally substituted pyrazol-1-yl, and optionally substituted quinolin-2-yl. Most preferred is that Z1, Z2 and Z4 each represent optionally substituted pyridin-2-yl.

The groups Z1, Z2 and Z4 if substituted, are preferably substituted by a group selected from C₁₋₄-alkyl, aryl, arylalkyl, heteroaryl, methoxy, hydroxy, nitro, amino, carboxyl, halo, and carbonyl. Preferred is that Z1, Z2 and Z4 are each substituted by a methyl group. Also, we prefer that the Z1 groups represent identical groups.

Each Q1 preferably represents a covalent bond or C₁-C₄-alkylene, more preferably a covalent bond, methylene or ethylene, most preferably a covalent bond.

Group Q preferably represents a covalent bond or C₁-C₄-alkylene, more preferably a covalent bond.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

Non-coordinated group T preferably represents hydrogen, hydroxy, methyl, ethyl, benzyl, or methoxy.

In one aspect, the group U in formula (IA) represents a coordinating group of the general formula (IIA):

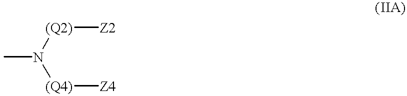

According to this aspect, it is preferred that Z2 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl or optionally substituted benzimidazol-2-yl.

It is also preferred, in this aspect, that Z4 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl, or an non-coordinating group selected from hydrogen, hydroxy, alkoxy, alkyl, alkenyl, cycloalkyl, aryl, or benzyl.

In preferred embodiments of this aspect, the ligand is selected from:

1,1-bis(pyridin-2-yl)-N-methyl-N-(pyridin-2-ylmethyl)methylamine;

1,1-bis(pyridin-2-yl)-N,N-bis(6-methyl-pyridin-2-ylmethyl)methylamine;

1,1-bis(pyridin-2-yl)-N,N-bis(5-carboxymethyl-pyridin-2-ylmethyl)methylamine;

1,1-bis(pyridin-2-yl)-1-benzyl-N,N-bis(pyridin-2-ylmethyl)methylamine; and

1,1-bis(pyridin-2yl)-N,N-bis(benzimidazol-2-ylmethyl)methylamine.

In a variant of this aspect, the group Z4 in formula (IIA) represents a group of the general formula (IIAa):

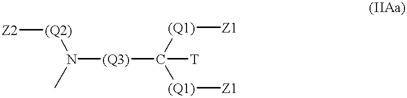

In this variant, Q4 preferably represents optionally substituted alkylene, preferably —CH₂—CHOH—CH₂— or —CH₂—CH₂—CH₂—. In a preferred embodiment of this variant, the ligand is:

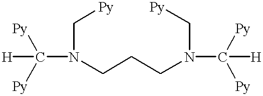

wherein —Py represents pyridin-2-yl.

In another aspect, the group U in formula (IA) represents a coordinating group of the general formula (IIIA):

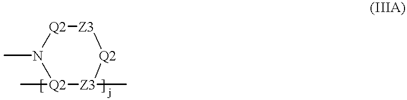

wherein j is 1 or 2, preferably 1.

According to this aspect, each Q2 preferably represents —(CH₂)ₙ— (n=2-4), and each Z3 preferably represents —N(R)— wherein R=−H or C₁₄-alkyl, preferably methyl.

In preferred embodiments of this aspect, the ligand is selected from:

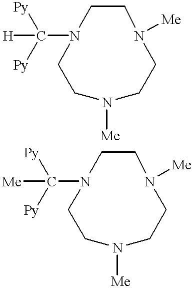

wherein —Py represents pyridin-2-yl.

In yet another aspect, the group U in formula (IA) represents a coordinating group of the general formula (IVA):

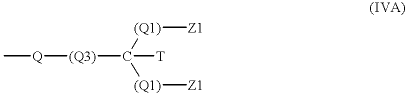

In this aspect, Q preferably represents —N(T)— (wherein T=—H, methyl, or benzyl) or pyridin-diyl.

In preferred embodiments of this aspect, the ligand is selected from:

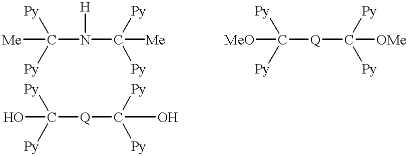

wherein —Py represents pyridin-2-yl, and —Q— represents pyridin-2,6-diyl.

(B) Ligands of the General Formula (IB):

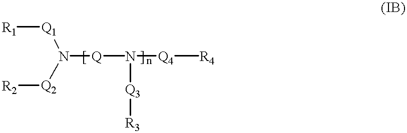

wherein

n=1 or 2, whereby if n=2, then each —Q₃—R₃ group is independently defined;

R₁, R₂, R₃, R₄ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E,

Q₁, Q2, Q3, Q4 and Q independently represent a group of the formula:

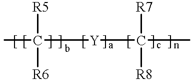

wherein

5≧a+b+c≧1; a=0-5; b=0-5; n=1 or 2;

Y independently represents a group selected from —O—, —S—, —SO—, SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least two of R₁, R₂, R₃, R₄ comprise coordinating heteroatoms and no more than six heteroatoms are coordinated to the same transition metal atom.

At least two, and preferably at least three, of R₁, R₂, R₃, R₄ independently represent a group selected from carboxylate, amido, -NH-C(NH)NH2, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

Preferably, substituents for groups R₁, R₂, R₃, R₄, when representing a heterocyclic or heteroaromatic ring, are selected from C₁₄-alkyl, aryl, arylalkyl, heteroaryl, methoxy, hydroxy, nitro, amino, carboxyl, halo, and carbonyl.

The groups Q₁, Q₂, Q₃, Q₄ preferably independently represent a group selected from —CH₂— and —CH₂CH₂—.

Group Q is preferably a group selected from —(CH₂)₂₋₄—, —CH₂CH (OH)CH₂—,

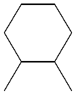

optionally substituted by methyl or ethyl,

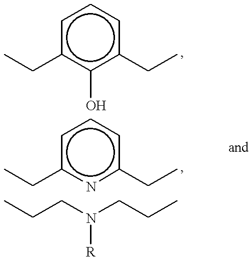

wherein R represents —H or C₁₋₄-alkyl.

Preferably, Q₁, Q₂, Q₃, Q₄ are defined such that a=b=0, c=1 and n=1, and Q is defined such that a=b=0, c=2 and n=1.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IIB):

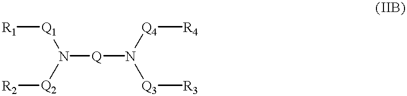

wherein

Q₁, Q₂, Q₃, Q₄ are defined such that a=b=0, c=1 or 2 and n=1;

Q is defined such that a=b=0, c=2,3 or 4 and n=1; and

R₁, R₂, R₃, R₄, R7, R8 are independently defined as for formula (I).

Preferred classes of ligands according to this aspect, as represented by formula (IB) above, are as follows:

(i) Ligands of the General Formula (IIB) Wherein:

R₁, R₂, R₃, R₄ each independently represent a coordinating group selected from carboxylate, amido, —NH— C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

Q is defined such that a=b=0, c=2 or 3 and n=1;

R₁, R₂, R₃, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) Ligands of the General Formula (IIB) Wherein:

R₁, R₂, R₃ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₄ represents a group selected from hydrogen, C₁₋₂₀ optionally substituted alkyl, C₁₋₂₀ optionally substituted arylalkyl, aryl, and C₁₋₂₀ optionally substituted NR₃+(wherein R=C₁₋₈-alkyl).

In this class, we prefer that:

Q is defined such that a=b=0, c=2 or 3 and n=1;

R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₄ represents a group selected from hydrogen, C₁₋₁₀ optionally substituted alkyl, C₁₋₅-furanyl, C₁₋₅ optionally substituted benzylalkyl, benzyl, C₁₋₅ is optionally substituted alkoxy, and C₁₋₂₀ optionally substituted N⁺Me₃.

(iii) Ligands of the General Formula (IIB) Wherein:

R₁, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₂, R₃ each independently represent a group selected from hydrogen, C1-20 optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₂, R₃ each independently represent a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

Examples of preferred ligands in their simplest forms are:

N,N′,N′-tris(3-methyl-pyridin-2-ylmethyl)-ethylenediamine;

N-trimethylammoniumpropyl-N,N′,N′-tris(pyridin-2-ylmethyl)-ethylenediamine;

N-(2-hydroxyethylene)-N,N′,N′-tris(pyridin-2-ylmethyl)-ethylenediamine;

N,N,N′,N′-tetrakis(3-methyl-pyridin-2-ylmethyl)-ethylenediamine;

N,N′-dimethyl-N,N′-bis(pyridin-2-ylmethyl)-cyclohexane-1,2-diamine;

N-(2-hydroxyethylene)-N,N′,N′-tris(3-methyl-pyridin-2-ylmethyl)-ethylenediamine;

N-methyl-N,N′,N′-tris(pyridin-2-ylmethyl)-ethylenediamine;

N-methyl-N,N′,N′-tris(5-ethyl-pyridin-2-ylmethyl)-ethylenediamine;

N-methyl-N,N′,N′-tris(5-methyl-pyridin-2-ylmethyl)-ethylenediamine;

N-methyl-N,N′,N′-tris(3-methyl-pyridin-2-ylmethyl)-ethylenediamine;

N-benzyl-N,N′,N′-tris(3-methyl-pyridin-2-ylmethyl)-ethylenediamine;

N-ethyl-N,N′,N′-tris(3-methyl-pyridin-2-ylmethyl)-ethylenediamine;

N,N,N′-tris(3-methyl-pyridin-2-ylmethyl)-N′(2′-methoxy-ethyl-1)-ethylenediamine;

N,N,N′-tris(1-methyl-benzimidazol-2-yl)-N′-methyl-ethylenediamine;

N-(furan-2-yl)-N,N′,N′-tris(3-methyl-pyridin-2-ylmethyl)-ethylenediamine;

N-(2-hydroxyethylene)-N,N′,N′-tris(3-ethyl-pyridin-2-ylmethyl)-ethylenediamine;

N-methyl-N,N′,N′-tris(3-methyl-pyridin-2-ylmethyl)ethylene-1,2-diamine;

N-ethyl-N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl-pyridin-2-ylmethyl)ethylene-1,2-diamine;

N-(2-methoxyethyl)-N,N′,N′-tris(3-methyl-pyridin-2-ylmethyl)ethylene-1,2-diamine;

N-methyl-N,N′,N′-tris(5-methyl-pyridin-2-ylmethyl)ethylene-1,2-diamine;

N-ethyl-N,N′,N′-tris(5-methyl-pyridin-2-ylmethyl)ethylene-1,2-diamine;

N-benzyl-N,N′,N′-tris(5-methyl-pyridin-2-ylmethyl)ethylene-1,2-diamine;

N-(2-hydroxyethyl)-N,N′,N′-tris(5-methyl-pyridin-2-ylmethyl)ethylene-1,2-diamine;

N-(2-methoxyethyl)-N,N′,N′-tris(5-methyl-pyridin-2-ylmethyl)ethylene-1,2-diamine;

N-methyl-N,N′,N′-tris(3-ethyl-pyridin-2-ylmethyl)ethylene-1,2-diamine;

N-ethyl-N,N′,N′-tris(3-ethyl-pyridin-2-ylmethyl)ethylene-1,2-diamine;

N-benzyl-N,N′,N′-tris(3-ethyl-pyridin-2-ylmethyl)ethylene-1,2-diamine;

N-(2-hydroxyethyl)-N,N′,N′-tris(3-ethyl-pyridin-2-ylmethyl ethylene-1,2-diamine;

N-(2-methoxyethyl)-N,N′,N′-tris(3-ethyl-pyridin-2-ylmethyl)ethylene-1,2-diamine;

N-methyl-N,N,N′-tris(5-ethyl-pyridin-2-ylmethyl)ethylene-1,2-diamine;

N-ethyl-N,N′,N′-tris(5-ethyl-pyridin-2-ylmethyl)ethylene-1,2-diamine;

N-benzyl-N,N′,N′-tris(5-ethyl-pyridin-2-ylmethyl)ethylene-1,2-diamine; and

N-(2-methoxyethyl)-N,N′,N′-tris(5-ethyl-pyridin-2-ylmethyl)ethylene-1,2-diamine.

More preferred ligands are:

N-methyl-N,N′,N′-tris(3-methyl-pyridin-2-ylmethyl)ethylene-1,2-diamine;

N-ethyl-N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl-pyridin-2-ylmethyl)ethylene-1,2-diamine; and

N-(2-methoxyethyl)-N,N′,N′-tris(3-methyl-pyridin-2-ylmethyl)ethylene-1,2-diamine.

(C) Ligands of the General Formula (IC):

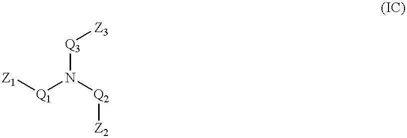

wherein

Z₁, Z₂ and Z₃ independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Q₁, Q₂, and Q₃ independently represent a group of the formula:

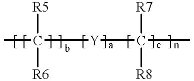

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₆-alkylene optionally substituted by C₁₋₄-alkyl, —F, —Cl, —Br or —I.

Z₁, Z₂ and Z₃ each represent a coordinating group, preferably selected from optionally substituted pyridin-2-yl, optionally substituted imidazol-2-yl, optionally substituted imidazol-4-yl, optionally substituted pyrazol-1-yl, and optionally substituted quinolin-2-yl. Preferably, Z₁, Z₂ and Z₃ each represent optionally substituted pyridin-2-yl.

Optional substituents for the groups Z₁, Z₂ and Z₃ are preferably selected from C₁₄-alkyl, aryl, arylalkyl, heteroaryl, methoxy, hydroxy, nitro, amino, carboxyl, halo, and carbonyl, preferably methyl.

Also preferred is that Q₁, Q₂ and Q₃ are defined such that a=b=0, c=1 or 2, and n=1.

Preferably, each Q₁, Q2 and Q3 independently represent C₁₋₄-alkylene, more preferably a group selected from —CH₂— and —CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C6-alkoxy, and C₀-C₂₀-alkylamide. Preferably, none of R5-R8 is linked together.

Preferably, the ligand is selected from tris(pyridin-2-ylmethyl)amine, tris(3-methyl-pyridin-2-ylmethyl)amine, tris(5-methyl-pyridin-2-ylmethyl)amine, and tris(6-methyl-pyridin-2-ylmethyl)amine.

(D) Ligands of the General Formula (ID):

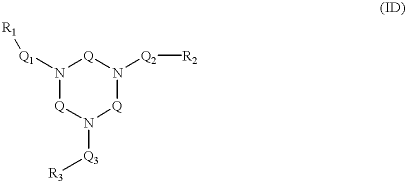

wherein

R₁, R₂, and R₃ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E;

Q independently represent a group selected from C₂₋₃-alkylene optionally substituted by H, benzyl or C₁₋₈-alkyl;

Q₁, Q₂ and Q₃ independently represent a group of the formula:

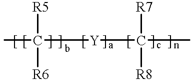

wherein

5≧a+b+c≧1; a=0-5; b=0-5; c=0-5; n=1 or 2;

Y independently represents a group selected from —O—, —S—, —SO—, SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₄-alkyl, —F, —Cl, —Br or —I,

provided that at least one, preferably at least two, of R₁, R₂ and R₃ is a coordinating group.

At least two, and preferably at least three, of R₁, R₂ and R₃ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, at least two of R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

Preferably, substituents for groups R₁, R₂, R₃, when representing a heterocyclic or heteroaromatic ring, are selected from C₁₄-alkyl, aryl, arylalkyl, heteroaryl, methoxy, hydroxy, nitro, amino, carboxyl, halo, and carbonyl.

Preferably, Q₁, Q₂ and Q₃ are defined such that a=b=0, c=1,2,3 or 4 and n=l. Preferably, the groups Q₁, Q₂ and Q₃ independently represent a group selected from —CH₂— and —CH₂CH₂—.

Group Q is preferably a group selected from —CH₂CH₂— and —CH₂CH₂CH₂—.

The groups R5, R6, R7, R8 preferably independently represent a group selected from —H, hydroxy-C₀-C₂₀-alkyl, halo-C₀-C20-alkyl, nitroso, formyl-C₀-C₂₀-alkyl, carboxyl-C₀-C₂₀-alkyl and esters and salts thereof, carbamoyl-CO-C20-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IID):

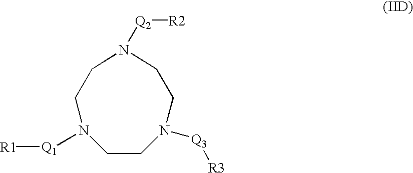

wherein R1, R2, R3 are as defined previously for R₁, R₂, R₃, and Q₁, Q₂, Q₃ are as defined previously.

Preferred classes of ligands according to this preferred aspect, as represented by formula (IID) above, are as follows:

(i) Ligands of the General Formula (IID) Wherein:

R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) Ligands of the General Formula (IID) Wherein:

two of R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

one of R1, R2, R3 represents a group selected from hydrogen, C₁₋₂₀ optionally substituted alkyl, C₁₋₂₀ optionally substituted arylalkyl, aryl, and C1-20 optionally substituted NR₃⁺ (wherein R=C₁₋₈-alkyl).

In this class, we prefer that:

two of R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

one of R1, R2, R3 represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

In especially preferred embodiments, the ligand is selected from:

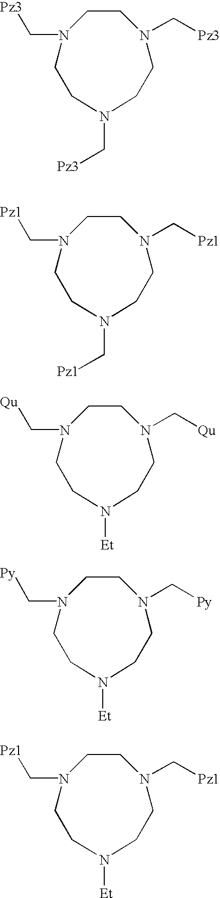

wherein —Et represents ethyl, —Py represents pyridin-2-yl, Pz3 represents pyrazol-3-yl, Pz1 represents pyrazol-1-yl, and Qu represents quinolin-2-yl.

(E) Ligands of the General Formula (IE):

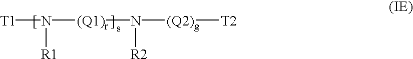

wherein

g represents zero or an integer from 1 to 6;

r represents an integer from 1 to 6;

s represents zero or an integer from 1 to 6;

Q1 and Q2 independently represent a group of the formula:

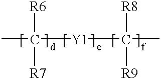

wherein

5≧d+e+f≧1; d=0-5; e=0-5; f=0-5;

each Y1 independently represents a group selected from —O——S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

if s>1, each —[—N(R1)—(Q1)ᵣ—]— group is independently defined;

R1, R2, R6, R7, R8, R9 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R6 together with R7, or R8 together with R9, or both, represent oxygen,

or R6 together with R8 and/or independently R7 together with R9, or R6 together with R9 and/or independently R7 together with R8, represent C₁₋₆-alkylene optionally substituted by C₁₋₄-alkyl, —F, —Cl, —Br or —I;

or one of R1-R9 is a bridging group bound to another moiety of the same general formula;

T1 and T2 independently represent groups R4 and R5, wherein R4 and R5 are as defined for R1-R9, and if g=0 and s>0, R1together with R4, and/or R2 together with R5, may optionally independently represent ═CH—RO₁, wherein R10 is as defined for R1-R9, or

T1 and T2 may together (—T2—T1—) represent a covalent bond linkage when s>1 and g>0;

if T1 and T2 together represent a single bond linkage, Q1 and/or Q2 may independently represent a group of the formula: ═CH—[—Y1—]ₑ—CH═ provided R1 and/or R2 are absent, and R1 and/or R2 may be absent provided Q1 and/or Q2 independently represent a group of the formula:

═CH—[—Y1—]ₑ—CH═.

The groups R1-R9 are preferably independently selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulpho-C₀-C₂₀-alkyl and esters and salts thereof, sulphamoyl-C₀-C₂₀-alkyl, amino-C₀-C₂₀-alkyl, aryl-C₀-C₂₀-alkyl, heteroaryl-C₀-C₂₀-alkyl, C₀-C₂₀-alkyl, alkoxy-C₀-C₈-alkyl, carbonyl-C₀-C₆-alkoxy, and aryl-C₀-C₆-alkyl and C₀-C₂₀-alkylamide.

One of R1-R9 may be a bridging group which links the ligand moiety to a second ligand moiety of preferably the same general structure. In this case the bridging group is independently defined according to the formula for Q1, Q2, preferably being alkylene or hydroxy-alkylene or a heteroaryl-containing bridge, more preferably C₁₋₆-alkylene optionally substituted by C₁₋₄-alkyl, —F, —Cl, —Br or —I.

In a first variant according to formula (IE), the groups T1 and T2 together form a single bond linkage and s>1, according to general formula (IIE):

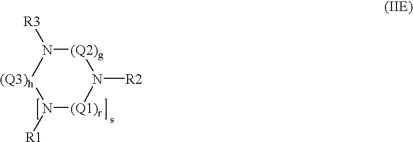

wherein R3 independently represents a group as defined for R1-R9; Q3 independently represents a group as defined for Q1, Q2; h represents zero or an integer from 1 to 6; and s=s−1.

In a first embodiment of the first variant, in general formula (IIE), s=1, 2 or 3; r=g=h=1; d=2 or 3; e=f=O; R6=R7=H, preferably such that the ligand has a general formula selected from:

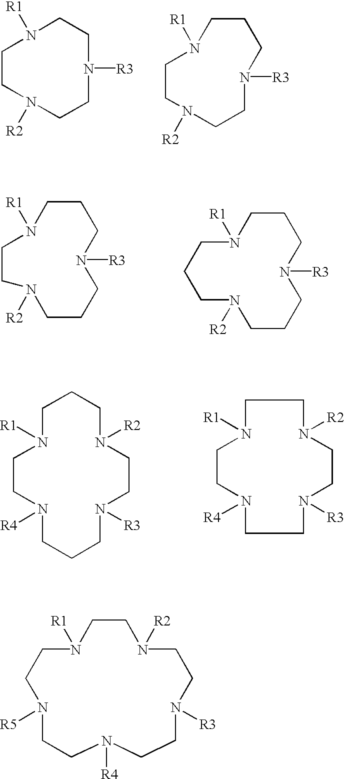

In these preferred examples, R1, R2, R3 and R4 are preferably independently selected from —H, alkyl, aryl, heteroaryl, and/or one of R1-R4 represents a bridging group bound to another moiety of the same general formula and/or two or more of R1-R4 together represent a bridging group linking N atoms in the same moiety, with the bridging group being alkylene or hydroxy-alkylene or a heteroaryl-containing bridge, preferably heteroarylene. More preferably, R1, R2, R3 and R4 are independently selected from —H, methyl, ethyl, isopropyl, nitrogen-containing heteroaryl, or a bridging group bound to another moiety of the same general formula or linking N atoms in the same moiety with the bridging group being alkylene or hydroxy-alkylene.

In a second embodiment of the first variant, in general formula (IIE), s=2 and r=g=h=1, according to the general formula:

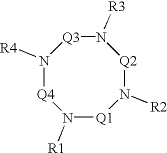

In this second embodiment, preferably R1-R4 are absent; both Q1 and Q3 represent ═CH—[—Y1—]ₑ—CH═; and both Q2 and Q4 represent —CH₂—[—Y1—]ₙ—CH₂.

Thus, preferably the ligand has the general formula:

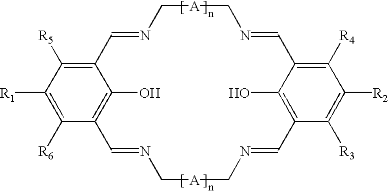

wherein A represents optionally substituted alkylene optionally interrupted by a heteroatom; and n is zero or an integer from 1 to 5.

Preferably, R1-R6 represent hydrogen, n=1 and A=—CH₂—, —CHOH—, —CH₂N(R)CH₂— or —CH₂CH₂N(R)CH₂CH₂— wherein R represents hydrogen or alkyl, more preferably A=—CH₂—, —CHOH— or —CH₂CH₂NHCH₂CH₂—.

In a second variant according to formula (IE), T1 and T2 independently represent groups R4, R5 as defined for R1-R9, according to the general formula (IIIE):

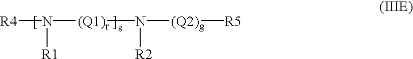

In a first embodiment of the second variant, in general formula (IIIE), s=1; r=1; g=0; d=f=1; e=0-4; Y1=—CH₂—; and R1 together with R4, and/or R2 together with R5, independently represent ═CH-R10, wherein R10 is as defined for R1-R9. In one example, R2 together with R5 represents ═CH—R10, with R1 and R4 being two separate groups. Alternatively, both R1 together with R4, and R2 together with R5 may independently represent ═CH—R10. Thus, preferred ligands may for example have a structure selected from:

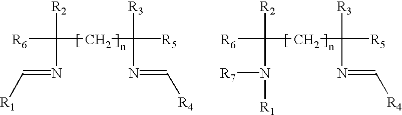

wherein n=0-4.

Preferably, the ligand is selected from:

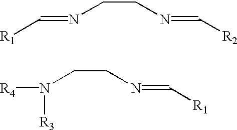

wherein R1 and R2 are selected from optionally substituted phenols, heteroaryl-C₀-C₂₀-alkyls, R3 and R4 are selected from —H, alkyl, aryl, optionally substituted phenols, heteroaryl-C₀-C₂₀-alkyls, alkylaryl, aminoalkyl, alkoxy, more preferably R1 and R2 being selected from optionally substituted phenols, heteroaryl-C₀-C₂-alkyls, R3 and R4 are selected from —H, alkyl, aryl, optionally substituted phenols, nitrogen-heteroaryl-C₀-C₂-alkyls.

In a second embodiment of the second variant, in general formula (IIIE), s=1; r=1; g=0; d=f=1; e=1-4; Y1=—C(R′)(R″), wherein R′ and R″ are independently as defined for R1-R9.

Preferably, the ligand has the general formula:

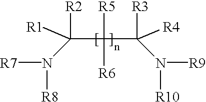

The groups R1, R2, R3, R4, R5 in this formula are preferably —H or C₀-C₂₀-alkyl, n=0 or 1, R6 is —H, alkyl, —OH or —SH, and R7, R8, R9, R10 are preferably each independently selected from —H, C₀-C₂₀-alkyl, heteroaryl-C₀-C₂₀-alkyl, alkoxy-C₀-C₈-alkyl and amino-C₀-C₂₀-alkyl.

In a third embodiment of the second variant, in general formula (IIIE), s=0; g=1; d=e=0; f=1-4. Preferably, the ligand has the general formula:

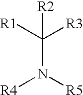

This class of ligand is particularly preferred according to the invention.

More preferably, the ligand has the general formula:

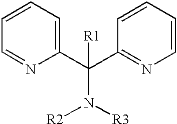

wherein R1, R2, R3 are as defined for R2, R4, R5.

In a fourth embodiment of the second variant, the ligand is a pentadentate ligand of the general formula (IVE):

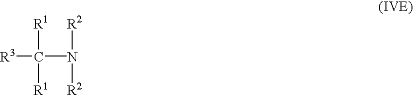

wherein

each R¹, R² independently represents —R⁴—R⁵,

R³ represents hydrogen, optionally substituted alkyl, aryl or arylalkyl, or —R⁴—R⁵,

each R⁴ independently represents a single bond or optionally substituted alkylene, alkenylene, oxyalkylene, aminoalkylene, alkylene ether, carboxylic ester or carboxylic amide, and

each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

Ligands of the class represented by general formula (IVE) are also particularly preferred according to the invention. The ligand having the general formula (IVE), as defined above, is a pentadentate ligand. By ‘pentadentate’ herein is meant that five hetero atoms can coordinate to the metal M ion in the metal-complex.

In formula (IVE), one coordinating hetero atom is provided by the nitrogen atom in the methylamine backbone, and preferably one coordinating hetero atom is contained in each of the four R¹ and R² side groups. Preferably, all the coordinating hetero atoms are nitrogen atoms.

The ligand of formula (IVE) preferably comprises at least two substituted or unsubstituted heteroaryl groups in the four side groups. The heteroaryl group is preferably a pyridin-2-yl group and, if substituted, preferably a methyl- or ethyl-substituted pyridin-2-yl group. More preferably, the heteroaryl group is an unsubstituted pyridin-2-yl group.

Preferably, the heteroaryl group is linked to methylamine, and preferably to the N atom thereof, via a methylene group. Preferably, the ligand of formula (IVE) contains at least one optionally substituted amino-alkyl side group, more preferably two amino-ethyl side groups, in particular 2-(N-alkyl)amino-ethyl or 2-(N,N-dialkyl)amino-ethyl.

Thus, in formula (IVE) preferably R¹ represents pyridin-2-yl or R² represents pyridin-2-yl-methyl. Preferably R² or R¹ represents 2-amino-ethyl, 2-(N-(m)ethyl)amino-ethyl or 2-(N,N-di(m)ethyl)amino-ethyl. If substituted, R⁵ preferably represents 3-methyl pyridin-2-yl. R³ preferably represents hydrogen, benzyl or methyl.

Examples of preferred ligands of formula (IVE) in their simplest forms are:

(i) Pyridin-2-yl Containing Ligands such as:

N,N-bis(pyridin-2-yl-methyl)-bis(pyridin-2-yl)methylamine;

N,N-bis(pyrazol-1-yl-methyl)-bis(pyridin-2-yl)methylamine;

N,N-bis(imidazol-2-yl-methyl)-bis(pyridin-2-yl)methylamine;

N,N-bis(1,2,4-triazol-1-yl-methyl)-bis(pyridin-2-yl)methylamine;

N,N-bis(pyridin-2-yl-methyl)-bis(pyrazol-1-yl)methylamine;

N,N-bis(pyridin-2-yl-methyl)-bis(imidazol-2-yl)methylamine;

N,N-bis(pyridin-2-yl-methyl)-bis(1,2,4-triazol-1-yl)methylamine;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-2-phenyl-1-aminoethane;

N,N-bis(pyrazol-1-yl-methyl)-1,1-bis(pyridin-2-yl)-1-aminoethane;

N,N-bis(pyrazol-1-yl-methyl)-1,1-bis(pyridin-2-yl)-2-phenyl-1-aminoethane;

N,N-bis(imidazol-2-yl-methyl)-1,1-bis(pyridin-2-yl)-1-aminoethane;

N,N-bis(imidazol-2-yl-methyl)-1,1-bis(pyridin-2-yl)-2-phenyl-1-aminoethane;

N,N-bis(1,2,4-triazol-1-yl-methyl)-1,1-bis(pyridin-2-yl)-1-aminoethane;

N,N-bis(1,2,4-triazol-1-yl-methyl)-1,1-bis(pyridin-2-yl)-2-phenyl-1-aminoethane;

N,N-bis(pyridin-2-yl-methyl)-1,1-bis(pyrazol-1-yl)-1-aminoethane;

N,N-bis(pyridin-2-yl-methyl)-1,1-bis(pyrazol-1-yl)-2-phenyl-1-aminoethane;

N,N-bis(pyridin-2-yl-methyl)-1,1-bis(imidazol-2-yl)-1-aminoethane;

N,N-bis(pyridin-2-yl-methyl)-1,1-bis(imidazol-2-yl)-2-phenyl-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-1-aminohexane;

N,N-bis(pyridin-2-yl-methyl)-1,1-bis(pyridin-2-yl)-2-phenyl-1-aminoethane;

N,N-bis(pyridin-2-yl-methyl)-1,1-bis(pyridin-2-yl)-2-(4-sulphonic acid-phenyl)-1-aminoethane;

N,N-bis(pyridin-2-yl-methyl)-1,1-bis(pyridin-2-yl)-2-(pyridin-2-yl)-1-aminoethane;

N,N-bis(pyridin-2-yl-methyl)-1,1-bis(pyridin-2-yl)-2-(pyridin-3-yl)-1-aminoethane;

N,N-bis(pyridin-2-yl-methyl)-1,1-bis(pyridin-2-yl)-2-(pyridin-4-yl)-1-aminoethane;

N,N-bis(pyridin-2-yl-methyl)-1,1-bis(pyridin-2-yl)-2-(1-alkyl-pyridinium-4-yl)-1-aminoethane;

N,N-bis(pyridin-2-yl-methyl)-1,1-bis(pyridin-2-yl)-2-(1-alkyl-pyridinium-3-yl)-1-aminoethane;

N,N-bis(pyridin-2-yl-methyl)-1,1-bis(pyridin-2-yl)-2-(1-alkyl-pyridinium-2-yl)-1-aminoethane;

(ii) 2-amino-ethyl Containing Ligands such as:

N,N-bis(2-(N-alkyl)amino-ethyl)-bis(pyridin-2-yl)methylamine;

N,N-bis(2-(N-alkyl)amino-ethyl)-bis(pyrazol-1-yl)methylamine;

N,N-bis(2-(N-alkyl)amino-ethyl)-bis(imidazol-2-yl)methylamine;

N,N-bis(2-(N-alkyl)amino-ethyl)-bis(1,2,4-triazol-1-yl)methylamine;

N,N-bis(2-(N,N-dialkyl)amino-ethyl)-bis(pyridin-2-yl)methylamine;

N,N-bis(2-(N,N-dialkyl)amino-ethyl)-bis(pyrazol-1-yl)methylamine;

N,N-bis(2-(N,N-dialkyl)amino-ethyl)-bis(imidazol-2-yl)methylamine;

N,N-bis(2-(N,N-dialkyl)amino-ethyl)-bis(1,2,4-triazol-1-yl)methylamine;

N,N-bis(pyridin-2-yl-methyl)-bis(2-amino-ethyl)methylamine;

N,N-bis(pyrazol-1-yl-methyl)-bis(2-amino-ethyl)methylamine;

N,N-bis(imidazol-2-yl-methyl)-bis(2-amino-ethyl)methylamine;

N,N-bis(1,2,4-triazol-1-yl-methyl)-bis(2-amino-ethyl)methylamine.

More preferred ligands are:

N,N-bis(pyridin-2-yl-methyl)-bis(pyridin-2-yl)methylamine, hereafter referred to as N4Py.

N,N-bis(pyridin-2-yl-methyl)-1,1-bis(pyridin-2-yl)-1-aminoethane, hereafter referred to as MeN4Py,

N,N-bis(pyridin-2-yl-methyl)-1,1-bis(pyridin-2-yl)-2-phenyl-1-aminoethane, hereafter referred to as BzN4Py.

In a fifth embodiment of the second variant, the ligand represents a pentadentate or hexadentate ligand of general formula (VE):

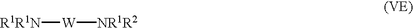

wherein

each R₁ independently represents —R³—V, in which R³ represents optionally substituted alkylene, alkenylene, oxyalkylene, aminoalkylene or alkylene ether, and V represents an optionally substituted heteroaryl group selected from pyridinyl, pyrazinyl, pyrazolyl, pyrrolyl, imidazolyl, benzimidazolyl, pyrimidinyl, triazolyl and thiazolyl;

W represents an optionally substituted alkylene bridging group selected from —CH₂CH₂—, —CH₂CH₂CH₂—, —CH₂CH₂CH₂CH₂—, —CH₂—C₆H₄—CH₂—, —CH₂—C₆H₁₀—CH₂—, and —CH₂—C₁₀H₆—CH₂—; and

R² represents a group selected from R¹, and alkyl, aryl and arylalkyl groups optionally substituted with a substituent selected from hydroxy, alkoxy, phenoxy, carboxylate, carboxamide, carboxylic ester, sulphonate, amine, alkylamine and N⁺(R⁴)₃, wherein R⁴ is selected from hydrogen, alkanyl, alkenyl, arylalkanyl, arylalkenyl, oxyalkanyl, oxyalkenyl, aminoalkanyl, aminoalkenyl, alkanyl ether and alkenyl ether.

The ligand having the general formula (VE), as defined above, is a pentadentate ligand or, if R¹—R², can be a hexadentate ligand. As mentioned above, by ‘pentadentate’ is meant that five hetero atoms can coordinate to the metal M ion in the metal-complex. Similarly, by ‘hexadentate’ is meant that six hetero atoms can in principle coordinate to the metal M ion. However, in this case it is believed that one of the arms will not be bound in the complex, so that the hexadentate ligand will be penta coordinating.

In the formula (VE), two hetero atoms are linked by the bridging group W and one coordinating hetero atom is contained in each of the three R¹ groups. Preferably, the coordinating heteroatoms are nitrogen atoms.

The ligand of formula (VE) comprises at least one optionally substituted heteroaryl group in each of the three R¹ groups. Preferably, the heteroaryl group is a pyridin-2-yl group, in particular a methyl- or ethyl-substituted pyridin-2-yl group. The heteroaryl group is linked to an N atom in formula (VE), preferably via an alkylene group, more preferably a methylene group. Most preferably, the heteroaryl group is a 3-methyl-pyridin-2-yl group linked to an N atom via methylene.

The group R² in formula (VE) is a substituted or unsubstituted alkyl, aryl or arylalkyl group, or a group R¹. However, preferably R² is different from each of the groups R¹ in the formula above. Preferably, R² is methyl, ethyl, benzyl, 2-hydroxyethyl or 2-methoxyethyl. More preferably, R² is methyl or ethyl.

The bridging group W may be a substituted or unsubstituted alkylene group selected from —CH₂CH₂—, —CH₂CH₂CH₂—, —CH₂CH₂CH—₂CH₂—, —CH₂—C₆H₄—CH₂—, —CH₂—C₆H₁₀—CH₂—, and —CH₂—C₁₀H₆—CH₂— (wherein —C₆H₄—, —C₆H₁₀—, —C₁₀H₆— can be ortho-, para-, or meta-C₆H₄—, —C₆H₁₀—, —C₁₀H₆—). Preferably, the bridging group W is an ethylene or 1,4-butylene group, more preferably an ethylene group.

Preferably, V represents substituted pyridin-2-yl, especially methyl-substituted or ethyl-substituted pyridin-2-yl, and most preferably V represents 3-methyl pyridin-2-yl.

(F) Ligands of the Classes Disclosed in WO-A-98/39098 and WO-A-98/39406.

(H) Ligand Having the Formula (HI):

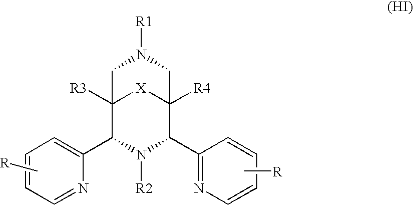

wherein each R is independently selected from: hydrogen, hydroxyl, —NH—CO—H, —NH—CO—C₁-C₄-alkyl, —NH₂, —NH—C1-C4-alkyl, and C₁-C₄-alkyl;

R1 and R2 are independently selected from:

C1-C4-alkyl,

C6-C10-aryl, and,

a group containing a heteroatom capable of coordinating to a transition metal, preferably wherein at least one of R1 and R2 is the group containing the heteroatom;

R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)ₙC(O)OR5 wherein R5 is C1-C₄-alkyl, n is from 0 to 4, and mixtures thereof; and,

X is selected from C═O, —[C(R6)₂]_{y}— wherein Y is from 0 to 3 each R6 is independently selected from hydrogen, hydroxyl, C1-C4-alkoxy and C₁-C₄-alkyl.

(I) A further class of ligands is the macropolycyclic rigid ligand of formula (I) having denticity of 3 or 4:

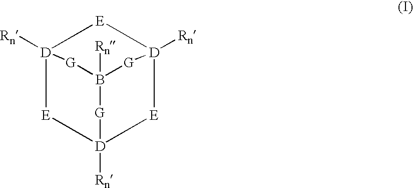

(ii) the macropolycyclic rigid ligand of formula (II) having denticity of 4 or 5

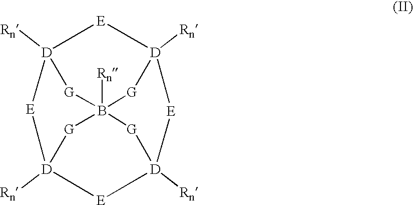

(iii) the macropolycyclic rigid ligand of formula (III) having denticity of 5 or 6:

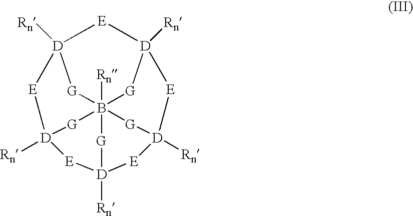

(iv) the macropolycyclic rigid ligand of formula (IV) having denticity of 6 or 7

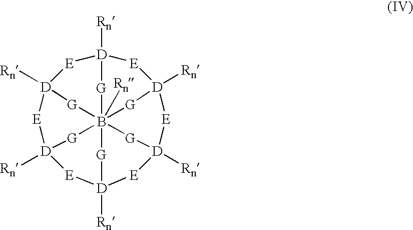

wherein in these formulas: each “E” is the moiety (CRₙ)ₐ—X—(CRₙ)_{a′}, wherein X is selected from the group consisting of O, S, NR and P, or a covalent bond, and preferably X is a covalent bond and for each E the sum of a+a′ is independently selected from 1 to 5, more preferably 2 and 3.

each “G” is the moiety (CRₙ)_{b}.

each “R” is independently selected from H, alkyl, alkenyl, alkynyl, aryl, alkylaryl

(e.g., benzyl), and heteroaryl, or two or more R are covalently bonded to form an aromatic, heteroaromatic, cycloalkyl, or heterocycloalkyl ring.

each “D” is a donor atom independently selected from the group consisting of N, O, S, and P, and at least two D atoms are bridgehead donor atoms coordinated to the transition metal (in the preferred embodiments, all donor atoms designated D are donor atoms which coordinate to the transition metal, in contrast with heteroatoms in the structure which are not in D such as those which may be present in E; the non-D heteroatoms can be non-coordinating and indeed are non-coordinating whenever present in the preferred embodiment).

“B” is a carbon atom or “D” donor atom, or a cycloalkyl or heterocyclic ring.

each “n” is an integer independently selected from 1 and 2, completing the valence of the carbon atoms to which the R moieties are covalently bonded.

each “n”′ is an integer independently selected from 0 and 1, completing the valence of the D donor atoms to which the R moieties are covalently bonded.

each “n”″ is an integer independently selected from 0,1, and 2 completing the valence of the B atoms to which the R moieties are covalently bonded.

each “a” and “a”′ is an integer independently selected from 0-5, preferably a+a′ equals 2 or 3, wherein the sum of all “a” plus “a′” in the ligand of formula (I) is within the range of from about 7 to about 11. The sum of all “a” plus “a” in the ligand of formula (II) is within the range of from about 6 (preferably 8) to about 12. The sum of all “a” plus “a′” in the ligand of formula (III) is within the range of from about 8 (preferably 10) to about 15, and the sum of all “a” plus “a′” in the ligand of formula (IV) is within the range of from about 10 (preferably 12) to about 18.

each “b” is an integer independently selected from 0-9, preferably 0-5 (wherein when b=0, (CRₙ)₀ represents a covalent bond), or in any of the above formulas, one or more of the (CRₙ)_{b} moieties covalently bonded from any D to the B atom is absent as long as at least two (CRₙ)_{b} covalently bond two of the D donor atoms to the B atom in the formula, and the sum of all “b” is within the range of from about 1 to about 5.

A preferred sub-group of the transition-metal complexes includes the Mn(II), Fe(II) and Cu(II) complexes of the ligand 1.2:

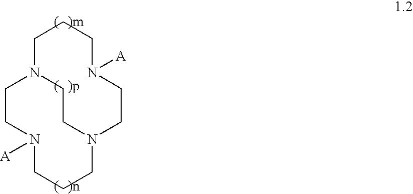

wherein m and n are integers from 0 to 2, p is an integer from 1 to 6, preferably m and n are both 0 or both 1 (preferably both 1 ), or m is 0 and n is at least 1; and p is 1;

and A is a nonhydrogen moiety preferably having no aromatic content; more particularly each A can vary independently and is preferably selected from methyl, ethyl, propyl, isopropyl, butyl, isobutyl, tert-butyl, C5-C20 alkyl, and one, but not both, of the A moieties is benzyl, and combinations thereof. In one such complex, one A is methyl and one A is benzyl.

Dichloro-5,12-dimethyl-1,5,8,12-tetraazabicyclo[6.6.2]hexadecane Manganese (II)

Dichloro-4,10-dimethyl-1,4,7,10-tetraazabicyclo[5.5.2]tetradecane Manganese(II)

Diaquo-5,12-dimethyl-1,5,8,12-tetraazabicyclo [6.6.2]hexadecane Manganese (II)

Hexafluorophosphate

Aquo-hydroxy-5,12-dimethyl-1,5,8,12-tetraazabicyclo[6.6.2]hexadecane Manganese(III)

Hexafluorophosphate

Diaquo-4,10-dimethyl-1,4,7,10-tetraazabicyclo[5.5.2]tetradecane Manganese(II)

Hexafluorophosphate

Diaquo-5,12-dimethyl-1,5,8,12-tetraazabicyclo[6.6.2]hexadecane Manganese(II)

Tetrafluoroborate

Diaquo-4,10-dimethyl-1,4,7,10-tetraazabicyclo [5.5.2]tetradecane Manganese(II) Tetrafluoroborate

Dichloro-5,12-dimethyl-1,5,8,12-tetraazabicyclo[6.6.2]hexadecane Manganese (III)

Hexafluorophosphate

Dichloro-5,12-di-n-butyl-1,5,8,12-tetraazabicyclo[6.6.2]hexadecane Manganese (II)

Dichloro-5, I 2-dibenzyl-1,5,8, I 2-tetraazabicyclo[6.6.2]hexadecane Manganese(II)

Dichloro-5-n-butyl-12-methyl-1,5,8,12-tetraazabicyclo[6.6.2]hexadecane Manganese (II)

Dichloro-5-n-octyl-12-methyl-I,5,8, I 2-tetraazabicyclo[6.6.2]hexadecane Manganese(II) Dichloro-5-n-butyl-12-methyl-I,5,8,12-tetraaza-bicyclo[6.6.2]hexadecane Manganese(II)

Dichloro-5,12-dimethyl-1,5,8,12-tetraazabicyclo[6.6.2]hexadecane Iron(II)

Dichloro-4,10-dimethyl-1,4,7,10-tetraazabicyclo[5.5.2]tetradecane Iron(II)

Dichloro-5,12-dimethyl-1,5,8,12-tetraazabicyclo[6.6.2]hexadecane Copper(II)

Dichloro-4,10-dimethyl-1,4,7,10-tetraazabicyclo[5.5.2]tetradecane Copper(II)

Dichloro-5,12-dimethyl-1,5,8,12-tetraazabicyclo[6.6.2]hexadecane Cobalt(II)

Dichloro-4,10-dimethyl-1,4,7,10-tetraazabicyclo[5.5.2]tetradecane Cobalt(II)

Dichloro 5,12-dimethyl-4-phenyl-1,5,8,12-tetraazabicyclo[6.6.2]hexadecane Manganese (II)

Dichloro-4,10-dimethyl-3-phenyl-1,4,7,10-tetraazabicyclo[5.5.2]tetradecane Manganese (II)

Dichloro-5,12-dimethyl-4,9-diphenyl-1,5,8,12-tetraazabicyclo[6.6.2]hexadecane Manganese (II)

Dichloro-4,10-dimethyl-3,8-diphenyl-1,4,7,10-tetraazabicyclo[5.5.2]tetradecane Manganese (II)

Dichloro-5,12-dimethyl-2,11-diphenyl-1,5,8,12-tetraazabicyclo[6.6.2]hexadecane Manganese (II)

Dichloro-4,10-dimethyl-4,9-diphenyl-1,4,7,10-tetraazabicyclo[5. 5.2]tetradecane Manganese(II)

Dichloro-2,4,5,9,11,12-hexamethyl-1,5,8,12-tetraazabicyclo[6.6.2]hexadecane Manganese (II)

Dichloro-2,3,5,9,10,12-hexamethyl-1,5,8,12-tetraazabicyclo[6.6.2]hexadecane Manganese(II)

Dichloro-2,2,4,5,9,9,11,12-octamethyl-1,5,8,12-tetraazabicyclo [6.6.2]hexadecane Manganese (II)

Dichloro-2,2,4,5,9,11,12-octamethyl-1,5,8,12-tetraazabicyclo[6.6.2]hexadecane Manganese(II)

Dichloro-3,3,5,10,10,12-hexamethyl-1,5,8,12-tetraazabicyclo[6.6.2]hexadecane Manganese(II)

Dichloro-3,5,10,12-tetramethyl-1,5,8,12-tetraazabicyclo[6.6.2]hexadecane Manganese(II)

Dichloro-3-butyl-5,10,12-trimethyl-1,5,8,12-tetraazabicyclo [6.6.2]hexadecane Manganese (II)

Dichloro-1,5,8,12-tetraazabicyclo[6.6.2]hexadecane Manganese (II)

Dichloro-1,4,7,10-tetraazabicyclo[5.5.2]tetradecane Manganese(II)

Dichloro-1,5,8,12-tetraazabicyclo[6.6.2]hexadecane Iron(II)

Dichloro-1,4,7,10-tetraazabicyclo[5.5.2]tetradecane Iron(II)

Aquo-chloro-2-(2-hydroxyphenyl)-5,12-dimethyl,5,8,12-tetraazabicyclo[6.6.2]hexadecane Manganese (II)

Aquo-chloro-10-(2-hydroxybenzyl)-4,10-dimethyl-1,4,7,10-tetraazabicyclo[5.5.2]tetradecane Manganese(II)

Chloro-2-(2-hydroxybenzyl)-5-methy 1,5,8,12-tetraazabicyclo[6. 6.2]hexadecane Manganese(II)

Chloro-10-(2-hydroxybenzyl)-4-methyl-1,4,7,10-tetraazabicyclo[5.5.2]tetradecane Manganese (II)

Chloro-5-methyl-12-(2-picolyl)-1,5,8,12-tetraazabicyclo[6.6.2]hexadecane Manganese(II) Chloride

Chloro-4-methyl-10-(2-picolyl)-1,4,7,10-tetraazabicyclo[5.5.2]tetradecane Manganese(II) Chloride

Dichloro-5-(2-sulphato)dodecyl-12-methyl-I,5,8,12-tetraazabicyclo[6.6.2]hexadecane Manganese (III)

Aquo-Chloro-5-(2-sulphato)dodecyl-12-methyl-1,5,8,12-tetraazabicyclo [6.6.2]hexadecane Manganese (II)

Aquo-Chloro-5-(3-sulphonopropyl)-12-methyl-1,5,8,12-tetraazabicyclo[6.6.2]hexadecane Manganese(II)

Dichloro-5-(Trimethylammoniopropyl)dodecyl-12-methyl-1,5,8,12-tetraazabicyclo[6.6.2]hexadecane Manganese(III)

Chloride

Dichloro-5,12-dimethyl-1,4,7,10,13-pentaazabicyclo[8.5.2]heptadecane Manganese (II)

Dichloro-14,20-dimethyl-1,10,14,20-tetraazatriyclo[8.6.6]docosa-3(8),4,6-triene Manganese (II)

Dichloro-4.11-dimethyl-1,4,7,11-tetraazabicyclo[6.5.2]pentadecane Manganese (II)

Dichloro-5,12-dimethyl-1,5,8,12-tetraazabicyclo[7.6.2]heptadecane Manganese(II)

Dichloro-5.13-dimethyl-1,5,9,13-tetraazabicyclo[7.7.2]heptadecane Manganese(II)

Dichloro-3,10-bis(butylcarboxy)-5,12-dimethyl-1,5,8,12-tetraazabicyclo[6.6.2]hexadecane Manganese(II)

Diaquo-3,10-dicarboxy-5,12-dimethyl-1,5,8,12-tetraazabicyclo[6.6.2]hexadecane Manganese (II)

Chloro-20-methyl-1,9,20,24,25-pentaaza-tetracyclo[7.7.7.1^{3,7}.1^{11,15}]pentacosa-3,5,7(24),11,1315(25)-hexaene manganese (II) Hexafluorophosphate

Trifluoromethanesulphono-20-methyl-1,9,20,24,25-pentaaza-tetracyclo[7.7.7.1^{3,7}.1^{11,15}]pentacosa-3,5,7(24),11,13,15(25)-hexaene Manganese (II) trifluoromethanesulphonate

Trifluoromethanesulphono-20-methyl-1,9,20,24,25-pentaaza-tetracyclo[7.7.7.1^{3,7}.1^{11,15}.]pentacosa-3,5,7(24),11,13,15(25)-hexaene Iron(II) trifluoromethanesulphonate

Chloro-5,12,17-trimethyl-1,5,8,12,17-pentaazabicyclo[6.6.5]nonadecane Manganese (II)

hexafluorophosphate

Chloro-4,10,15-trimethyl-1,4,7,10,15-pentaazabicyclo[5.5.5]heptadecane Manganese (II)

hexafluorophosphate

Chloro-5,12,17-trimethyl-1,5,8,12,17-pentaazabicyclo[6.6.5]nonadecane Manganese (II) chloride

Chloro-4,10,15-trimethyl-1,4,7,10,15-pentaazabicyclo[5.5.5]heptadecane Manganese(II) chloride

The invention further includes the compositions which include the transition-metal complexes, preferably the Mn, Fe, Cu and Co complexes, or preferred cross-bridged macropolycyclic ligands having the formula:

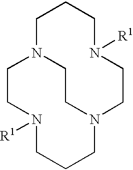

wherein in this formula “R1” is independently selected from H, and linear or branched, substituted or unsubstituted C1-C20 alkyl, alkylaryl, alkenyl or alkynyl, more preferably R1 is alkyl or alkylaryl; and preferably all nitrogen atoms in the macropolycyclic rings are coordinated with the transition metal.

Also preferred are cross-bridged macropolycyclic ligands having the formula:

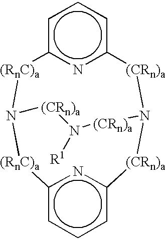

wherein in this formula:

each “n” is an integer independently selected from 1 and 2, completing the valence of the carbon atom to which the R moieties are covalently bonded;

each “R” and “R1” is independently selected from H, alkyl, alkenyl, alkynyl, aryl, alkylaryl (e.g., benzyl), and heteroaryl, or R and/or R1 are covalently bonded to form an aromatic, heteroaromatic, cycloalkyl, or heterocycloalkyl ring, and wherein preferably all R are H and R1 are independently selected from linear or branched, substituted or unsubstituted C₁-C₂₀ alkyl, alkenyl or alkynyl;

each “a” is an integer independently selected from 2 or 3;

preferably all nitrogen atoms in the macropolycyclic rings are coordinated with the transition metal. In terms of the present invention, even though any of such ligands are known, the invention encompasses the use of these ligands in the form of their transition-metal complexes as oxidation catalysts, or in the form of the defined catalytic systems.

In like manner, included in the definition of the preferred cross-bridged macropolycyclic ligands are those having the formula:

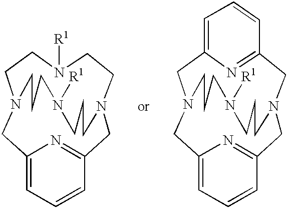

wherein in either of these formulae, “R¹” is independently selected from H, or, preferably, linear or branched, substituted or unsubstituted C1-C20 alkyl, alkenyl or alkynyl; and preferably all nitrogen atoms in the macropolycyclic rings are coordinated with the transition metal.

The present invention has numerous variations and alternate embodiments. Thus, in the foregoing catalytic systems, the macropolycyclic ligand can be replaced by any of the following:

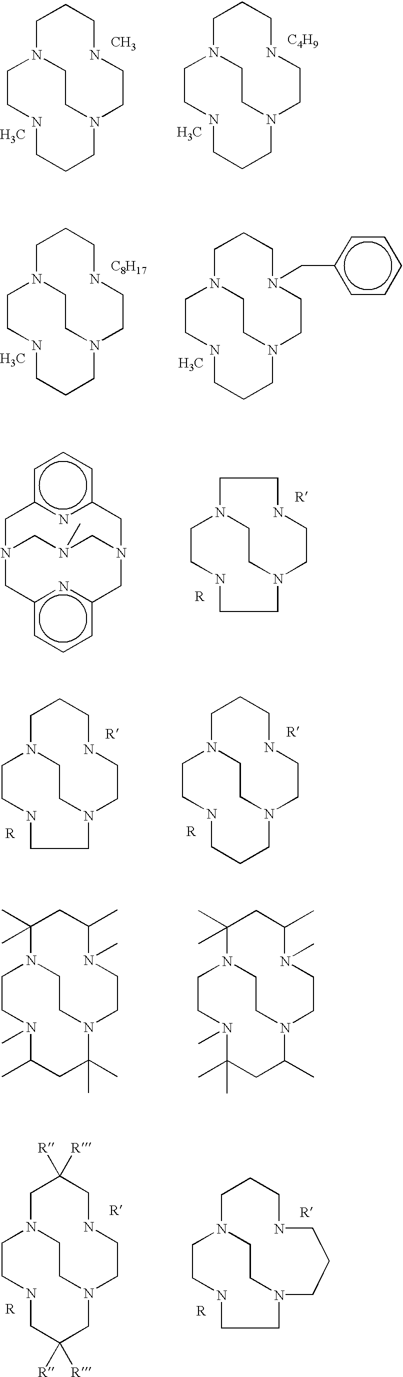

In the above, the R, R′, R″, R′″ moieties can, for example, be methyl, ethyl or propyl. (Note that in the above formalism, the short straight strokes attached to certain N atoms are an alternate representation for a methyl group).

While the above illustrative structures involve tetra-aza derivatives (four donor nitrogen atoms), ligands and the corresponding complexes in accordance with the present invention can also be made, for example from any of the following:

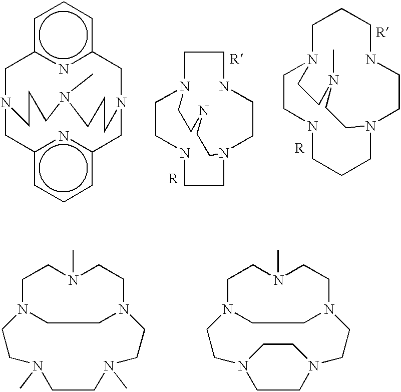

Moreover, using only a single organic macropolycycle, preferably a cross-bridged derivative of cyclam, a wide range of oxidation catalyst compounds of the invention may be prepared; numerous of these are believed to be novel chemical compounds. Preferred transition-metal catalysts of both cyclam-derived and non-cyclam-derived cross-bridged kinds are illustrated, but not limited, by the following:

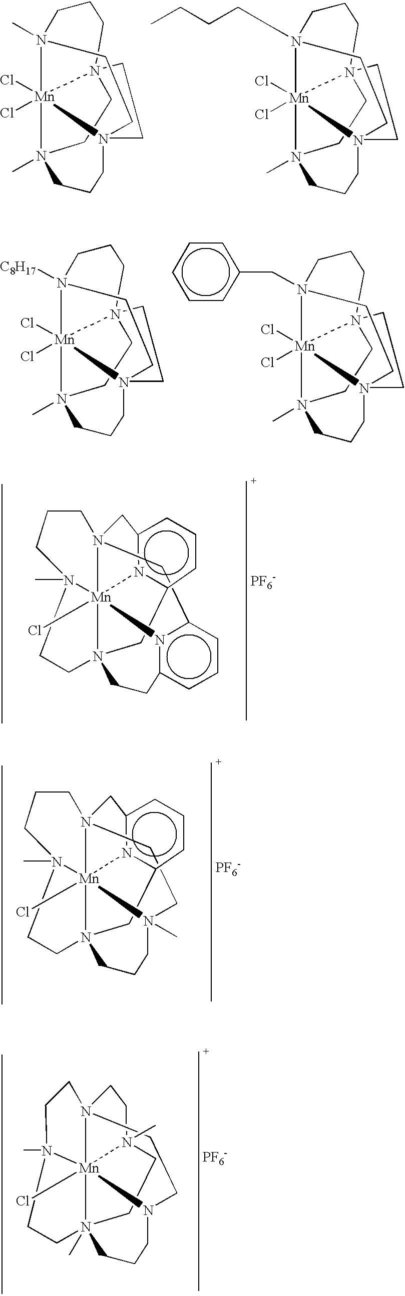

In other embodiments of the invention, transition-metal complexes, such as the Mn, Fe, Co, or Cu complexes, especially (II) and/or (III) oxidation state complexes, of the hereinabove-identified metals with any of the following ligands are also included:

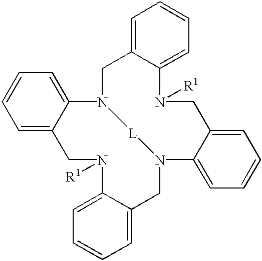

wherein R1 is independently selected from H (preferably non-H) and linear or branched, substituted or unsubstituted C1-C20 alkyl, alkenyl or alkynyl and L is any of the linking moieties given herein, for example 1.10 or 1.11;

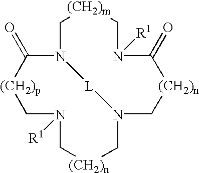

wherein R1 is as defined supra; m, n, o and p can vary independently and are integers which can be zero or a positive integer and can vary independently while respecting the provision that the sum m+n+o+p is from 0 to 8 and L is any of the linking moieties defined herein;

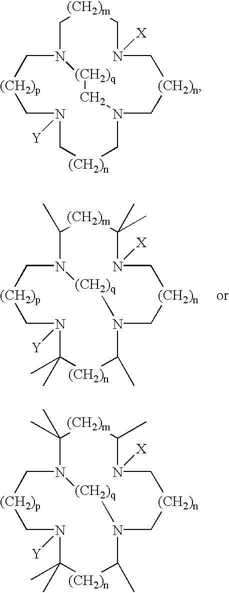

wherein X and Y can be any of the R1 defined supra, m, n, o and p are as defined supra and q is an integer, preferably from 1 to 4; or, more generally,

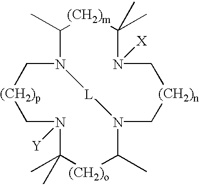

wherein L is any of the linking moieties herein, X and Y can be any of the R1 defined supra, and m, n, o and p are as defined supra. Alternately, another useful ligand is:

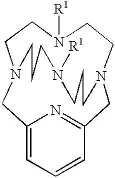

wherein R1 is any of the R1 moieties defined supra.

Pendant Moieties

Macropolycyclic rigid ligands and the corresponding transition-metal complexes and oxidation catalytic systems herein may also incorporate one or more pendant moieties, in addition to, or as a replacement for, R1 moieties. Such pendant moieties are nonlimitingly illustrated by any of the following:

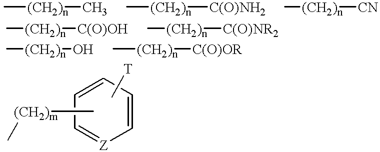

The counter ions Y in formula (Al) balance the charge z on the complex formed by the ligand L, metal M and coordinating species X. Thus, if the charge z is positive, Y may be an anion such as RCOO⁻, BPh₄⁻, ClO₄⁻, BF₄⁻, PF₆⁻, RSO₃⁻, RSO₄⁻, SO₄²⁻, NO₃⁻, F⁻, Cl⁻, Br⁻, or I⁻, with R being hydrogen, optionally substituted alkyl or optionally substituted aryl. If z is negative, Y may be a common cation such as an alkali metal, alkaline earth metal or (alkyl)ammonium cation.

Suitable counter ions Y include those which give rise to the formation of storage-stable solids. Preferred counter ions for the preferred metal complexes are selected from R⁷COO⁻, ClO₄⁻, BF₄⁻, PF₆⁻, RSO₃⁻ (in particular CF₃SO₃⁻), RSO₄⁻, SO₄²⁻, NO₃⁻, F⁻, Cl⁻, Br⁻, and I⁻, wherein R represents hydrogen or optionally substituted phenyl, naphthyl or C₁-C₄ alkyl.

Throughout the description and claims where generic groups have been used, for example alkyl, alkoxy, aryl. Unless otherwise specified the following are preferred group restrictions that may be applied to generic groups found within compounds disclosed herein:

alkyl: C1-C6-alkyl,

alkenyl: C2-C6-alkenyl,

cycloalkyl: C3-C8-cycloalkyl,

alkoxy: C1-C6-alkoxy,

alkylene: selected from the group consisting of: methylene; 1,1-ethylene; 1,2-ethylene; 1,1-propylene; 1,2-propylene; 1,3-propylene; 2,2-propylene; butan-2-ol-1,4-diyl; propan-2-ol-1,3-diyl; and 1,4-butylene,

aryl: selected from homoaromatic compounds having a molecular weight under 300,

arylene: selected from the group consisting of: 1,2-benzene; 1,3-benzene; 1,4-benzene; 1,2-naphthalene; 1,3-naphthalene; 1,4-naphthalene; 2,3-naphthalene; phenol-2,3-diyl; phenol-2,4-diyl; phenol-2,5-diyl; and phenol-2,-6-diyl,

heteroaryl: selected from the group consisting of: pyridinyl; pyrimidinyl; pyrazinyl; triazolyl, pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl,

heteroarylene: selected from the group consisting of: pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; and imidazole-2,4-diyl,

heterocycloalkyl: selected from the group consisting of: pyrrolinyl; pyrrolidinyl; morpholinyl; piperidinyl; piperazinyl; hexamethylene imine; and oxazolidinyl,

amine: the group —N(R)₂ wherein each R is independently selected from: hydrogen; C1-C6-alkyl; C1-C6-alkyl-C6H5; and phenyl, wherein when both R are C1-C6-alkyl both R together may form an —NC3 to an —NC5 heterocyclic ring with any remaining alkyl chain forming an alkyl substituent to the heterocyclic ring,

halogen: selected from the group consisting of: F; Cl; Br and I,

sulphonate: the group —S(O)₂OR, wherein R is selected from: hydrogen; C1-C6-alkyl; phenyl; C1-C6-alkyl-C6H5; Li; Na; K; Cs; Mg; and Ca,

sulphate: the group —OS(O)₂OR, wherein R is selected from: hydrogen; C1-C6-alkyl; phenyl; C1-C6-alkyl-C6H5; Li; Na; K; Cs; Mg; and Ca,

sulphone: the group —S(O)₂R, wherein R is selected from: hydrogen; C1-C6-alkyl; phenyl; C1-C6-alkyl-C6H5 and amine (to give sulphonamide) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring,

carboxylate derivative: the group —C(O)OR, wherein R is selected from: hydrogen, C1-C6-alkyl; phenyl; C1-C6-alkyl-C6H5, Li; Na; K; Cs; Mg; and Ca,

carbonyl derivative: the group —C(O)R, wherein R is selected from: hydrogen; C1-C6-alkyl; phenyl; C1-C6-alkyl-C6H5 and amine (to give amide) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring,

phosphonate: the group —P(O)(OR)₂, wherein each R is independently selected from: hydrogen; C1-C6-alkyl; phenyl; C1-C6-alkyl-C6H5; Li; Na; K; Cs; Mg; and Ca,

phosphate: the group —OP(O)(OR)2, wherein each R is independently selected from: hydrogen; C1-C6-alkyl; phenyl; C1-C6-alkyl-C6H5; Li; Na; K; Cs; Mg; and Ca,

phosphine: the group —P(R)₂, wherein each R is independently selected from: hydrogen; C1-C6-alkyl; phenyl; and C1-C6-alkyl-C6H5,

phosphine oxide: the group —P(O)R₂, wherein R is independently selected from: hydrogen; C1-C6-alkyl; phenyl; and C1-C6-alkyl-C6H5; and amine (to give phosphonamidate) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring.

Unless otherwise specified the following are more preferred group restrictions that may be applied to groups found within compounds disclosed herein:

alkyl: C1-C4-alkyl,

alkenyl: C3-C6-alkenyl,

cycloalkyl: C6-C8-cycloalkyl,

alkoxy: C1-C4-alkoxy,

alkylene: selected from the group consisting of: methylene; 1,2-ethylene; 1,3-propylene; butan-2-ol-1,4-diyl; and 1,4-butylene,

aryl: selected from group consisting of: phenyl; biphenyl, naphthalenyl; anthracenyl; and phenanthrenyl,

arylene: selected from the group consisting of: 1,2-benzene, 1,3-benzene, 1,4-benzene, 1,2-naphthalene, 1,4-naphthalene, 2,3-naphthalene and phenol-2,6-diyl,

heteroaryl: selected from the group consisting of: pyridinyl; pyrimidinyl; quinolinyl; pyrazolyl; triazolyl; isoquinolinyl; imidazolyl; and oxazolidinyl,

heteroarylene: selected from the group consisting of: pyridin-2,3-diyl; pyridin-2,4-diyl; pyridin-2,6-diyl; pyridin-3,5-diyl; quinolin-2,3-diyl; quinolin-2,4-diyl; isoquinolin-1,3-diyl; isoquinolin-1,4-diyl; pyrazol-3,5-diyl; and imidazole-2,4-diyl,

heterocycloalkyl: selected from the group consisting of: pyrrolidinyl; morpholinyl; piperidinyl; and piperazinyl,

amine: the group —N(R)₂, wherein each R is independently selected from: hydrogen; C1-C6-alkyl; and benzyl,

halogen: selected from the group consisting of: F and Cl,

sulphonate: the group —S(O)₂OR, wherein R is selected from: hydrogen; C1-C6-alkyl; Na; K; Mg; and Ca,

sulphate: the group -OS(O)₂OR, wherein R is selected from: hydrogen; C1-C6-alkyl; Na; K; Mg; and Ca,

sulphone: the group —S(O)₂R, wherein R is selected from: hydrogen; C1-C6-alkyl; benzyl and amine selected from the group: —NR′2, wherein each R′ is independently selected from: hydrogen; C1-C6-alkyl; and benzyl,

carboxylate derivative: the group —C(O)OR, wherein R is selected from hydrogen; Na; K; Mg; Ca; C1-C6-alkyl; and benzyl,

carbonyl derivative: the group: —C(O)R, wherein R is selected from: hydrogen; C1-C6-alkyl; benzyl and amine selected from the group: —NR′2, wherein each R′ is independently selected from: hydrogen; C1-C6-alkyl; and benzyl,

phosphonate: the group —P(O)(OR)₂, wherein each R is independently selected from: hydrogen; C1-C6-alkyl, benzyl; Na; K; Mg; and Ca,

phosphate: the group —OP(O)(OR)₂, wherein each R is independently selected from: hydrogen; C1-C6-alkyl; benzyl; Na; K; Mg; and Ca,

phosphine: the group —P(R)₂, wherein each R is independently selected from: hydrogen; C1-C6-alkyl; and benzyl,

phosphine oxide: the group —P(O)R₂, wherein R is independently selected from: hydrogen; C1-C6-alkyl; benzyl and amine selected from the group: —NR′2, wherein each R′ is independently selected from: hydrogen; C1-C6-alkyl; and benzyl.

The aforementioned references also contain reverent materials that may be used in an air bleaching composition to be used with the present invention.

Peroxyl Species

As one skilled in the art will appreciate there are numerous suitable peroxy species that will provide a bleaching activity. In many instances it is also preferred to use a peroxyl activating catalyst for the treatment of stains. Suitable peroxy species are found in the following general classes of compounds: peroxyacids; peroxides, peroxysulphates, peroxyphosphates, etc. The peroxy bleaches that can be utilised in the present invention include hydrogen peroxide, hydrogen peroxide-liberating compounds, hydrogen peroxide-generating systems, peroxy acids and their salts and peroxy acid bleach percursor system, monoperoxysulphate salts, peroxyphosphate salt and mixtures thereof. Hydrogen peroxide sources are well known in the art. They include alkali metal peroxides, organic peroxidase bleaching compounds such as urea peroxide, and inorganic persalt bleaching compounds, such as the alkali metal perborates, percarbonates, peroxyphosphates, and peroxysulphates. Mixtures of two or more of such compounds may also be suitable. Particularly preferred are sodium perborate or sodium percarbonate. These bleaching compounds may further be employed in conjunction with a peroxyacid bleaching precursor, for example tetraacetylethylenediamine (TAED) or sodium nonanoyloxybenzenesulphonate (SNOBS). The use of a peroxyacid bleaching precursor as detailed above for bleaching a substrate will likely reduce the presence of bacteria on washed laundry, improve bleaching performance and in the case of white fabric increase the overall whiteness appearance of the white fabric. Peroxyacid bleaches and their precursors are known and amply described in literature. Suitable examples of this general class include magnesium monoperoxyphthalate hexahydrate (INTEROX), metachloroperbenzoic acid, 4-nonylamino-4-oxoperoxybutyric acid and diperoxydodecanedioic acid, 6-nonylamino-6-oxoperoxycaproic acid (NAPAA), peroxybenzoic acid, ring-substituted peroxybenzoic acids, e.g., peroxy-o-naphthoic acid, peroxylauric acid, peroxystearic acid, 1,9-diperoxyazelaic acid, 1,12-diperoxydodecanedioic acid, diperoxybrassylic acid, diperoxysebacic acid, diperoxyisophthalic acid, 2-decyldiperoxybutane-1,4-dioic acid, 4,4,′-sulphonybisperoxybenzoic acid, N,N-phthaloylaminoperoxycaproic acid (PAP), and nonanoyloxybenzenesulphonate (SNOBS). Other examples of peroxyacid bleaches and their precursors are described in Chemistry & Industry (Oct. 15, 1990), 647-653, an article by Grime and Clauss.

Bleach Activators may also be applied in the treatment of the stain. Bleach Activators are discussed in detail in WO0050549, pages 27 to 30 of which are herein incorporated by reference. In addition, a redox enzyme may be present to activate hydrogen peroxide if present e.g. a peroxidase, see for example WO0047707 and WO9412621.

It is preferred that the peroxygen bleach contains a sequestrant. The following are examples of sequestrants that may be used: ethylenediamine tetraacetate (EDTA); diethylenetriamine pentamethylene phosphonate (DETPMP); ethylenediamine tetramethylene phosphonate (EDTMP); diethylene triamine penta (methylene phosphonic acid) (DTPMP); hexamethylene diamine tetraphosphonic acid (HMDTP); nitrilotrismethylenephosphonic acid (NTMP); and, hydroxyethyl-1,1-diphosphonic acid (HEDP). The aforementioned examples also extend to salts thereof. The purpose of the sequesterent is to chelate metal ions thereby extending the lifetime of the peroxygen bleach.

Applicator

Suitable applicators for the application of the peroxyl precursor species or peroxyl precursor to the stain include sprays, pens, roller-ball devices, bars, soft solid applicator sticks and impregnated cloths or cloths containing microcapsules. Such means are well known in the analogous art of deodorant application and/or in spot treatment of textiles. The applicator may also contain a peroxyl-bleaching catalyst. If required the peroxyl precursor species or peroxyl precursor and peroxyl-bleaching catalyst are dispensed such that they come into contact after dispensing. It will be evident to one skilled in the art what substances need to be kept separate before application to preserve their active lifetimes. Such means of individual application of ingredients will be evident to one skilled in the art.

### EXAMPLES

Synthesis of the Complex [(MeN4Py)FeCl]Cl:

The MeN4py ligand (N,N-bis(pyridin-2-yl-methyl)-1,1-bis(pyridin-2-yl)-1-aminoethane) was prepared as described elsewhere (EP 0 909 809 A2).

MeN4Py ligand (33.7 g; 88.5 mmoles) was dissolved in 500 ml dry methanol. Small portions of FeCl₂.4H₂O (0.95eq; 16.7g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under vacuum (40° C.). El. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

Experimental Protocol

To an aqueous solution containing 10 mM carbonate buffer (pH 10) with 0.6 g/l Na-LAS (linear alkylbenzene sulphonate), stained cloths were added and stirred for 30 minutes at 30° C. (controls). In a second series of experiments, the same tests were done in the presence of 10 μM of [FeMeN4py)Cl]Cl. The optical qualities of the cloths were then measured immediately after rinsing with water and/or after 24 h drying at 30° C. Results are shown in Table 1. The optical qualities of the cloths were measured with a Linotype-Hell scanner (ex Linotype). The change in colour (bleaching) is expressed as a ΔE value. The measured colour difference (ΔE) between the washed cloth and a clean cotton cloth is defined as follows:

ΔE=[(ΔL)²+(Δa)²+(Δb)²]^{½},

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978. A lower value for the AE values in the Table 1, shows a better cleaning performance. The controls showed little change in AE. Cloths with the following types of stains were used in the experiments: TO (tomato oil), BC-1 (tea), and CS-12 (blackcurrant). The following results were reproducible.

TABLE 1

| | | TO | | BC-1 |
|---|---|---|---|---|
| | TO | air | BC-1 | air |
| | (control) | bleaching | (control) | bleaching |
| ΔE (t = 0) | 20.2 | 7.3 | 17.7 | 17.5 |
| ΔE (t = 1) | 19.5 | 4.4 | 17.7 | 17.5 |

It is evident from Table 1 that the tea stain (BC-1) has undergone little if any discernible air bleaching in comparison to the tomato oil stain.

Post-treatment Protocol

Subsequent treatment of the BC-1 (tea Stain) with a dilute 2 mM aqueous PAP (N,N-phthaloylaminoperoxycaproic acid) solution showed a significant discernible change in colour towards the white after a few minutes.

Pre-treatment Protocol

The following experiment illustrates pre-treatment results on stains resistant to air bleaching. In Table 2, ΔE values reflect a comparison with the original stained cloth in contrast to the results given in Table 1. Hence a higher value of LE is indicative of a greater bleaching activity. Substantially the same conditions were employed as described in the experimental protocol except with slight modification as is evident from Table 2. The stained cloths employed were BC-1 (tea) and CS-12 (blackcurrant stain, ex CFT).

TABLE 2

| Stain | System | ΔE |
|---|---|---|
| BC-1 | Buffer/LAS | 2 |
| BC-1 | Buffer/LAS/H₂O₂ | 3 |
| BC-1 | ([Fe (MeN4py) Cl] Cl)/H₂O₂ (10 μM) | 4 |
| CS-12 | Buffer/LAS | 2 |
| CS-12 | Buffer/LAS/H₂O₂ | 4 |
| CS-12 | ([Fe (MeN4py) Cl] Cl)/H₂O₂ (10 μM) | 7 |

The results shown in Table 2 illustrate the effectiveness of hydrogen peroxide in bleaching air bleaching resistant stains. In addition, the synergetic combination of a peroxyl-bleaching catalyst in combination with hydrogen peroxide is exemplified.

1. A commercial bleaching composition comprising an air bleaching catalyst for bleaching a substrate with atmospheric oxygen, the bleaching composition upon addition to an aqueous medium providing an aqueous bleaching medium substantially devoid of a peroxygen bleach or a peroxy-based or peroxyl-generating bleach system, together with instructions for the local application of a peroxygen bleach or a peroxy-based or a peroxyl-generating bleach system to a fabric stain before or after washing.

2. A bleaching composition according to claim 1, wherein the instructions are for the treatment of catechol-type or polyphenolics-type or polycyclic hydroxylated aromatic-type stains.

3. A bleaching composition according to claim 2, wherein the instructions are for the treatment of a stain selected from tea, coffee, red wine, blackberry, blackcurrant, blueberry, banana and the like.

4. A laundry cleaning kit comprising the bleaching composition according to claim 1, wherein the air bleaching catalyst is comprising a N,N-bis(pyridin-2-yl-methyl)-1,1-bis(pyridin-2-yl)-1-aminoethane moiety.

5. A laundry cleaning kit comprising the commercial bleaching composition according to claim 1, together with an applicator comprising a peroxygen bleach or a peroxy-based or peroxyl-generating bleach system for local application of the peroxygen bleach or the peroxy-based or the peroxyl-generating bleach system to a stained substrate.

6. A laundry cleaning kit comprising the commercial bleaching composition according to claim 5, wherein the applicator comprises a peroxygen bleach.

7. A laundry cleaning kit comprising the commercial bleaching composition according to claim 6, wherein the applicator comprises a peroxyl-activating catalyst.

8. A laundry cleaning kit comprising the commercial bleaching composition according to claim 6, wherein the applicator further comprises a sequestrant.
